(19) United States
(12) Patent Application Publication
(10) Pub. No.: US 2003/0167424 A1
(43) Pub. Date: Sep. 4, 2003

(54) Microcomputer capable of identifying instruction executed at abnormal event

(76) Inventors: Masayuki Konishi, Tokyo (JP); Yoshihisa Hori, Tokyo (JP); Hiromichi Miura, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/227,277

(22) Filed: Aug. 26, 2002

(30) Foreign Application Priority Data
Mar. 1, 2002 (JP) 2002-56279

(51) Int. Cl. H04B 1/74

(52) U.S. Cl. 714/47

(57) ABSTRACT

A microcomputer including a test-only RAM, a WDT (watchdog timer) and a clock controller. The test-only RAM stores information present on the address bus and data bus during the operation in a single-chip mode. The WDT counts a specified time interval according to a stored-ROM program in such a manner that it does not underflow. If the WDT underflows during the operation in the single-chip mode, it makes a decision that an abnormal event occurs, and outputs an underflow signal. The clock controller halts writing the address bus information and data bus information into the test-only RAM in response to the underflow signal. The microcomputer can easily identify an instruction which is being executed when a malfunction such as runaway occurs in the single-chip mode.

### BACKGROUND OF THE INVENTION

1. Field of the Invention

The present invention relates to a microcomputer including a ROM, and particularly to a microcomputer for verifying an abnormal event occurring during the operation based on a stored program in a ROM (single-chip mode).

2. Description of Related Art

Generally, microcomputers are known which include a ROM such as a mask ROM, EPROM or flash ROM in a chip. This type of microcomputers usually have two modes: a mode based on a stored program in the ROM, the so-called single-chip mode; and an external-memory operation mode based on a program stored in an external memory.

FIG. 11 shows a port configuration in the single-chip mode; and FIG. 12 shows a port configuration in the external-memory operation mode. In these figures, the microcomputer 11 comprises 32 ports. The ports are used not only as input and output ports PORT00-PORT07, PORT10-PORT17, PORT20-PORT27 and PORT30-PORT37, but also as data ports D0-D15 and address ports A0-A15.

More specifically, as indicated by underlines in FIG. 11, all the ports are used as the input and output ports PORT00-PORT07, PORT10-PORT17, PORT20-PORT27 and PORT30-PORT37 in the single-chip mode.

On the other hand, in the external-memory operation mode, the input and output ports PORT00-PORT07 are used as the data ports D0-D7 as indicated by underlines in FIG. 12. Likewise, the input and output ports PORT10-PORT17 are used as the data ports D8-D15. Furthermore, the input and output ports PORT20-PORT27 are used as the address ports A0-A7, and the input and output ports PORT30-PORT37 are used as the address ports A8-A15.

As described above, all the ports are used as the input and output ports in the single-chip mode so that no data access operation takes place between these ports and the external memory. Accordingly, even if a malfunction such as runaway occurs in the microcomputer 11 during the single-chip mode, it is difficult to identify an instruction that is being executed when the malfunction such as runaway takes place. In other words, it is difficult to identify the malfunction unless specific data indicating the malfunction is output from the input and output ports when the microcomputer 11 has the malfunction.

With the foregoing configuration, the conventional microcomputer cannot detect a malfunction such as runaway even if it takes place in the single-chip mode. Thus, it is difficult for the conventional microcomputer to identify the instruction that is being executed when the malfunction occurs.

### SUMMARY OF THE INVENTION

The present invention is implemented to solve the foregoing problem. It is therefore an object of the present invention to provide a microcomputer capable of detecting whether a malfunction such as runaway takes place during the single-chip mode operation, and easily identifying the instruction that is being executed when the malfunction occurs.

According to a first aspect of the present invention, there is provided a microcomputer comprising: a test-only memory for sequentially storing address bus information and data bus information during operation based on a stored program; an abnormal event detector for detecting an abnormal event in the operation based on the stored program, and for producing an abnormal event detection signal; and a controller for halting writing the address bus information and data bus information after the abnormal event in response to the abnormal event detection signal. It offers an advantage of being able to easily identify the instruction that is being executed when a malfunction such as runaway occurs because the address bus information and data bus information at the malfunction can be obtained.

According to a second aspect of the present invention, there is provided a microcomputer comprising: a test mode setting register for setting a test-mode entry signal that indicates a starting time point of abnormal event detection of the stored program; a CPU for successively writing address bus information and data bus information during operation based on the stored program at least into an unused area of the test mode setting register in response to a test-mode entry signal placed in the test mode setting register; an abnormal event detector for detecting an abnormal event in the operation based on the stored program, and for producing an abnormal event detection signal; and a controller for halting writing the address bus information and data bus information after the abnormal event in response to the abnormal event detection signal. It offers an advantage of being able to easily identify the instruction that is being executed when the malfunction occurs in a single-chip mode, and to simplify the circuit configuration.

### BRIEF DESCRIPTION OF THE DRAWINGS

FIG. 1 is a block diagram showing a configuration of a microcomputer of an embodiment 1 in accordance with the present invention;

FIG. 2 is a block diagram showing a configuration of a test-only RAM in FIG. 1;

FIG. 3 is a diagram illustrating an example of internal clock signals;

FIG. 4 is a circuit diagram showing a configuration of the clock controller in FIG. 1;

FIG. 5 is a diagram illustrating a control operation of the clock controller;

FIG. 6 is a diagram illustrating test-mode entry control of the microcomputer of an embodiment 2 in accordance with the present invention;

FIG. 7 is an external view of the microcomputer of the embodiment 2;

FIG. 8 is a diagram illustrating an example of an SFR (Special Function Register) of the microcomputer of the embodiment 2;

FIG. 9 is a block diagram showing a configuration of a microcomputer of an embodiment 3 in accordance with the present invention;

FIG. 10 is a diagram showing a configuration of a memory area of the SFR;

FIG. 11 is a diagram showing a port configuration of a microcomputer in a single-chip mode; and

FIG. 12 is a diagram showing a port configuration of the microcomputer in an external-memory operation mode.

### DETAILED DESCRIPTION OF THE PREFERRED EMBODIMENTS

The invention will now be described with reference to the accompanying drawings.

Embodiment 1

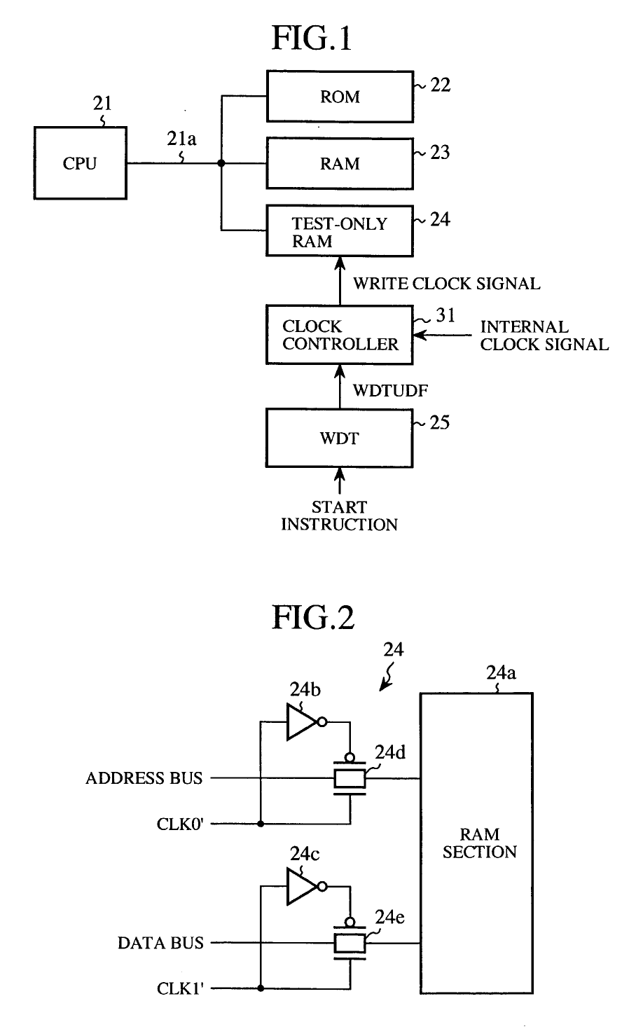

FIG. 1 is a block diagram showing a configuration of a microcomputer of an embodiment 1 in accordance with the present invention. In this figure, the reference numeral 21 designates a central processing unit (CPU) connected with a ROM 22, a RAM 23 and a test-only RAM 24 via an address bus and data bus 21a. The ROM 22 consists of a mask ROM or the like for storing a stored-ROM program executed by the CPU 21 during the single-chip mode operation. The RAM 23 stores data and the like generated during the operation. The test-only RAM 24 has a memory capacity of at least 64 bytes or so, for example, which is enough for storing information present on the address bus and data bus 21a (address bus information and data bus information) produced when the CPU 21 executes an instruction of the stored program. The test-only RAM 24 stores the address bus information and data bus information in synchronization with the internal clock signal. Every time the test-only RAM 24 stores information of an amount of the memory capacity (64 bytes, for example), the test-only RAM 24 writes the subsequent information over the stored information. Thus, the test-only RAM 24 records the state of the address bus and data bus as the address bus information and data bus information at every memory capacity interval (64 bytes, for example).

The reference numeral 25 designates a watchdog timer (WDT) connected to the test-only RAM 24 via a clock controller 31. The WDT 25 is activated at specified time intervals by the stored-ROM program, and halts its counting at the underflow when it counts down from a predetermined count value to zero. It is designed such that before the count value of the WDT 25 becomes zero, that is, before it underflows, the latest information present on the address bus and data bus 21a is overwritten on the test-only RAM 24 to restart the WDT 25. Accordingly, as long as the stored-ROM program supplies a start instruction at specified time intervals, the WDT 25 never enters an underflow state. In other words, the underflow occurs only when the stored-ROM program does not produce the start instruction at specified time intervals because of a failure in the stored-ROM program. In this case, the WDT 25 outputs an underflow signal WDTUDF.

Next, the operation of the present embodiment 1 will be described.

During the operation based on the stored-ROM program (single-chip mode), the information present on the address bus and data bus 24a (address bus information and data bus information) is written into the test-only RAM 24 in response to write clock signals CLK0′ and CLK1′. As mentioned above, the stored-ROM program has a function to deliver the start instruction to the WDT 25 at specified time intervals. Therefore, the WDT 25 repeats its start and reset every time the start instruction is supplied.

FIG. 2 is a block diagram showing a-configuration of the test-only RAM 24 shown in FIG. 1. As shown in FIG. 2, the test-only RAM 24 comprises a RAM section 24a, inverters 24b and 24c and switches 24d and 24e. The test-only RAM 24 is supplied with the write clock signals CLK0′ and CLK1′ from the clock controller 31 of FIG. 1.

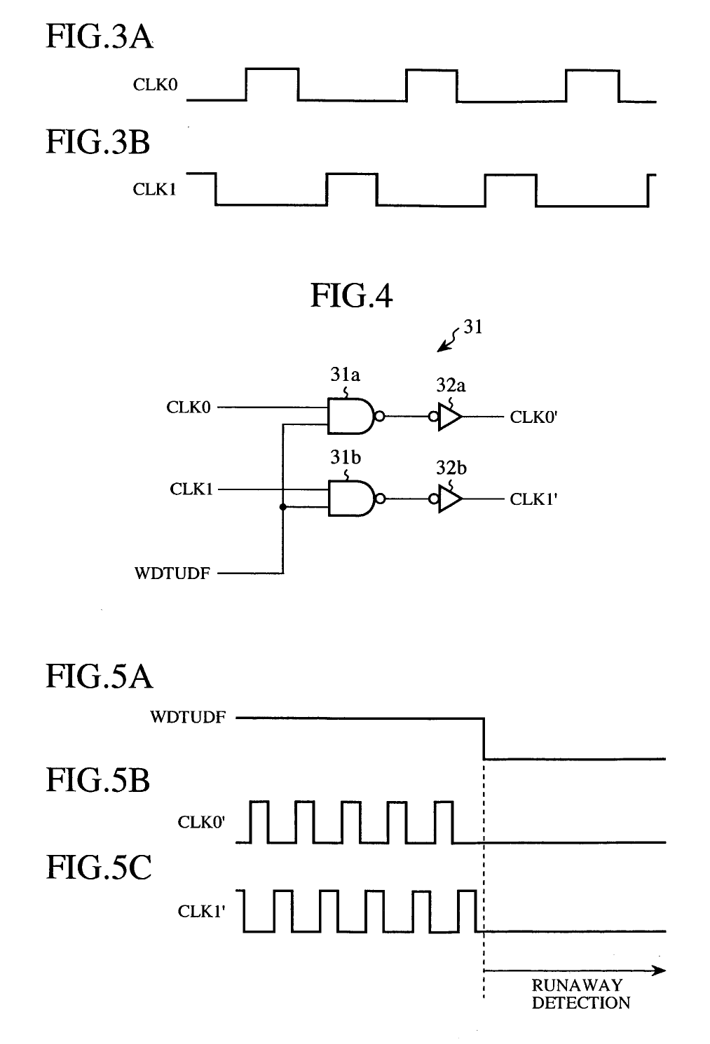

FIG. 3 shows an example of the internal clock signals; FIG. 3(a) illustrates the clock signal CLK0; and FIG. 3(b) illustrates the clock signal CLK1. As shown in FIG. 1, the clock controller 31, receiving the internal clock signals CLK0 and CLK1 as illustrated in FIG. 3 and the underflow signal WDTUDF, outputs the write clock signals CLK0′ and CLK1′. The inverters 24b and 24c are supplied with the write clock signals CLK0 ′ and CLK1 ′, respectively. Thus, the switches 24d and 24e capture the address on the address bus and data on the data bus in response to the write clock signals CLK0′ and CLK1′, thereby writing the address bus information and data bus information into the RAM section 24a.

FIG. 4 is a circuit diagram showing a configuration of the clock controller 31 in FIG. 1. As shown in this figure, the clock controller 31 comprises NAND gates 31a and 31b and inverters 32a and 32b. As long as the stored-ROM program operates normally, it sends the start instruction at specified time intervals. Therefore, the WDT 25 never underflows, producing no underflow signal WDTUDF.

FIG. 5 is a diagram showing the control by the clock controller 31: FIG. 5(a) illustrates the underflow signal WDTUDF; FIG. 5(b) illustrates the write clock signal CLK0′; and FIG. 5(c) illustrates the write clock signal CLK1′. In this example, unless the WDT 25 underflows, the underflow signal WDTUDF assumes a high level. The NAND gate 31a is supplied with the internal clock signal CLK0 and the underflow signal WDTUDF. On the other hand, the NAND gate 31b is supplied with the internal clock signal CLK1 and the underflow signal WDTUDF. As mentioned above, unless the WDT 25 underflows, the underflow signal WDTUDF is at the high level. Accordingly, the NAND gates 31a and 31b output signals (NAND signals) corresponding to the internal clock signals CKL0 and CKL1, which are called first and second NAND signals from now on. The first and second NAND signals are output from the inverters 32a and 32b as the write clock signals CKL0′ and CKL1′ as illustrated in FIG. 5.

On the other hand, if a malfunction such as runaway takes place during the operation based on the stored-ROM program, no start instruction will be produced at specified time intervals. As a result, the WDT 25 underflows, and changes the underflow signal WDTUDF from the high to low level as illustrated in FIG. 5(a). Thus, the NAND gates 31a and 31b output the high level regardless of the internal clock signals CKL0 and CKL1. In otherword, if the WDT 25 underflows (detects the runaway), and changes the underflow signal WDTUDF to the low level, the first and second NAND signals are placed at the high level. As a result, the inverters 32a and 32b always output the low level, halting the write clock signals CKL0′ and CKL1′ as shown in FIG. 5.

When the write clock signals CKL0′ and CKL1′ are halted in this way, the RAM section 24a does not write any new information, but holds the address bus information and data bus information obtained at the malfunction such as runaway. In this case, the underflow signal WDTUDF is output from an external port (not shown) of the microcomputer. Accordingly, monitoring the external port makes it possible to recognize that the WDT 25 underflows. Furthermore, the address bus information and data bus information at the malfunction can be obtained by analyzing the information read out of the test-only RAM 24 (RAM section 24a). Thus, the instruction executed at the malfunction can be identified.

As the external port, a new output port dedicated to the underflow signal WDTUDF can be provided, or an existing port can be utilized. On the other hand, to read the address bus information and data bus information from the test-only RAM 24, the CPU 21 can access the test-only RAM 24, and output the data through existing ports.

As described above, the present embodiment 1 is configured such that it includes the test-only RAM 24 for storing the address bus information and data bus information in the single-chip mode, and that if a malfunction such as runaway occurs during the operation based on the stored-ROM program, the WDT 25 underflows and. the write clock signal to be supplied to the test-only RAM 24 is halted. As a result, the present embodiment 1 can identify the address bus information and data bus information at the malfunction such as runaway, thereby making it possible to identify the instruction executed at the malfunction with ease.

Embodiment 2

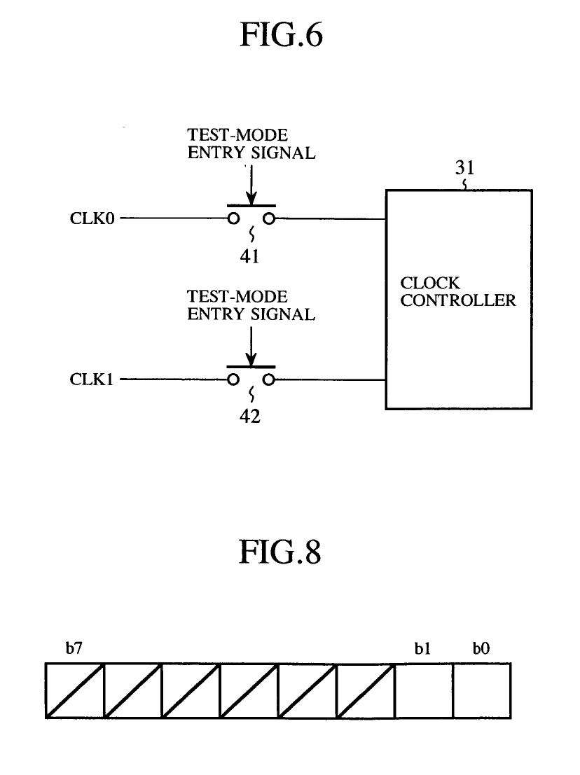

FIG. 6 is a block diagram illustrating the test-mode entry control of the microcomputer in an embodiment 2 in accordance with the present invention. In the microcomputer of the embodiment 2 as shown in FIG. 6, the internal clock signals CKL0 and CKL1 are supplied to the clock controller 31 via switches 41 and 42. The switches 41 and 42 are turned on and off in response to a test mode entry signal. Specifically, receiving the test-mode entry signal, the switches 41 and 42 are turned on, thereby supplying the internal clock signals CKL0 and CKL1 to the clock controller 31.

In this way, the address bus information and data bus information are written into the test-only RAM 24 only when an operation verification test is carried out in the single-chip mode (test mode). On the other hand, the data write into the test-only RAM 24 can be halted in advance in the normal mode (user mode).

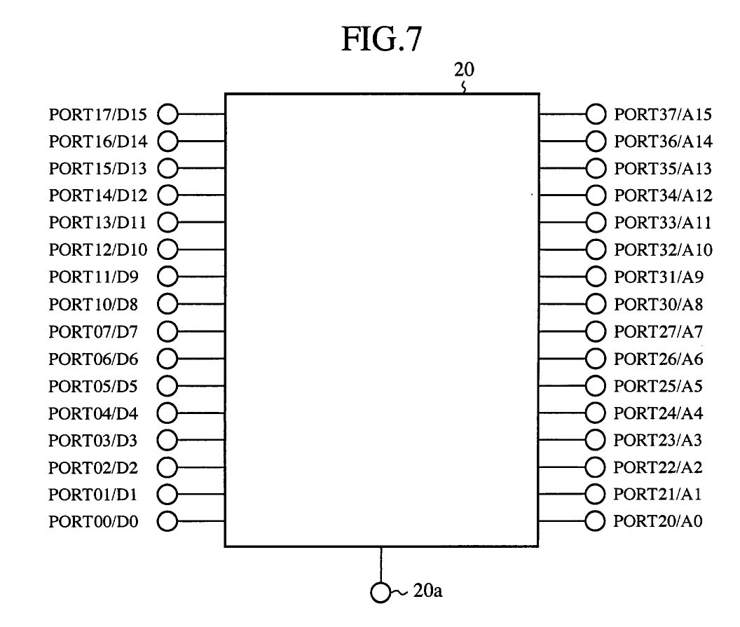

FIG. 7 is a diagram showing an external view of the microcomputer of the embodiment 2. As shown in FIG. 7, the microcomputer 20 of the embodiment 2 is supplied with the test-mode entry signal via a test-mode entry port 20a to be switched between the test mode and user mode. In other words, the test mode is set in response to the level of the test-mode entry port. For example, the test-mode entry port 20a is placed at the high level to start the test mode, and at the low level to start the user mode.

It is also possible for the microcomputer to include an SFR (Special Function Register) for setting the test-mode entry signal.

FIG. 8 is a diagram showing an example of the SFR of the microcomputer in the embodiment 2. The SFR can be used to start the test mode, for example. The SFR has areas b0-b7, and the test-mode entry information is set in the area b0. In this case, the test-mode entry information is set into the SFR via an external port (not shown). For example, when the test-mode entry information is “1”, the test-mode entry signal is placed at the high level, thereby starting the test mode. Thus, the clock controller 31 is supplied with the internal clock signals CKL0 and CKL1.

The SFR can also be used to hold the test-mode entry signal that is input via the test-mode entry port 20a. For example, the SFR can be connected directly to the test-mode entry port 20a so that the test-mode entry signal can be input as 8-bit serial data in synchronism with the clock signal.

In this way, the present embodiment 2 can be switched between the test mode and the user mode, and write the address bus information and data bus information into the test-only RAM only in the test mode. Thus, it can operate in either the test mode or user mode.

As described above, the present embodiment 2 is configured such that it supplies the write clock signal to the test-only RAM in response to the test-mode entry signal. As a result, it can be used with being switched between the test mode and user mode.

Embodiment 3

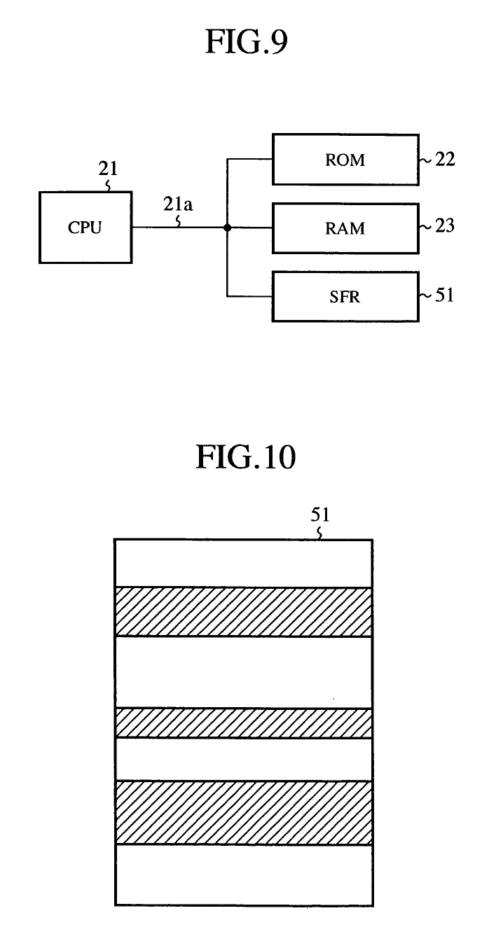

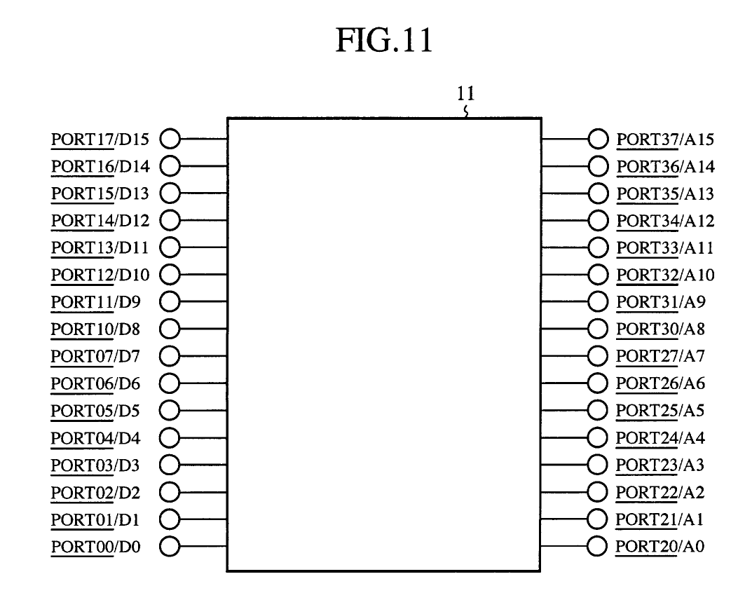

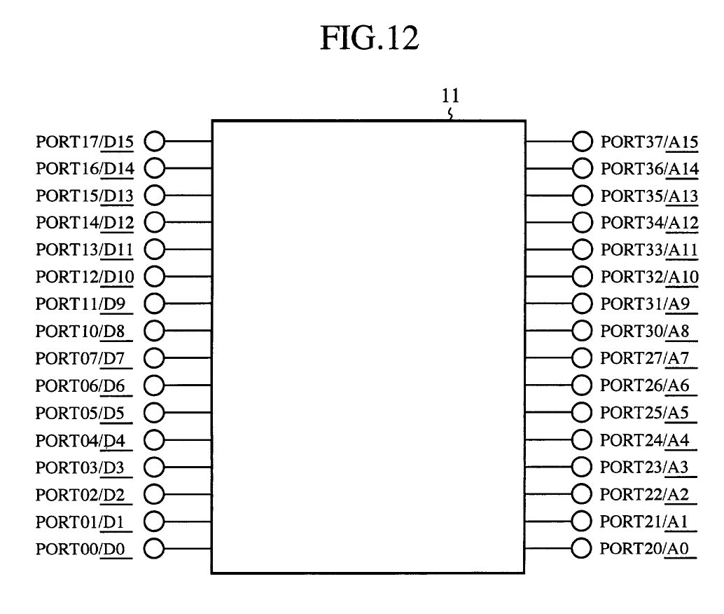

FIG. 9 is a block diagram showing a configuration of the microcomputer of an embodiment 3 in accordance with the present invention. In this figure, an SFR 51 with the same configuration as that of FIG. 8 is connected to the address bus and data bus 21a. The SFR 51 is also used as the test-only RAM 24 as shown in FIG. 1. Accordingly, in the test mode, in which the test-mode entry information is set in the SFR 51, the CPU 21 writes the address bus information and data bus information into an unused area of the SFR 51. In the example of FIG. 9, although the WDT 25 and other components as shown in FIG. 1 are omitted, the supply of the write clock signal is controlled in response to the underflow signal WDTUDF as described in connection with FIG. 1. Here, the same components as those of FIG. 1 are designated by the same reference numerals and the description thereof is omitted here.

Using the unused area of the SFR 51 as the test-only RAM makes it easier to switch the mode between the test mode and user mode, and makes the circuit configuration simpler than that using the test-only RAM 24.

FIG. 10 is a diagram showing a configuration of the memory area of the SFR 51, in which unused areas are shaded. In FIG. 10, the CPU 21 writes the address bus information and data bus information into the entire memory area of the SFR 51 including the used areas in the test mode. In this case, when the test-mode entry information is set, for example, the CPU 21 takes an access to the used areas of the SFR 51.

In addition, the CPU 21 can select the area b1 as shown in FIG. 8 as an area selection region, and write address bus information and data bus information into one of the RAM 23 and SFR 51 selectively in response to the area selection information set in the area b1. For example, when the area selection information indicates the RAM area, the CPU 21 writes the address bus information and data bus information into the RAM 23. On the other hand, when the area selection information indicates the SFR area, the CPU 21 writes the address bus information and data bus information into the SFR 51.

In either case, the WDT 25 as shown in FIG. 1 monitors the malfunction of the operation based on the stored-ROM program.

As described above, since the present embodiment 3 utilizes the unused area in the SFR 51 as the test-only RAM, it can simplify the circuit configuration. In addition, since the CPU 21 writes the address bus information and data bus information into the entire areas of the SFR 51 including the used areas in the test mode, the memory capacity can be increased in the test mode. Besides, writing the address bus information and data bus information into one of the RAM area and SFR area selectively can further increase the memory capacity available in the test mode.

Although the foregoing embodiments utilize the WDT 25 to detect the abnormal event, this is not essential. It can be replaced by any circuit that can detect an abnormal event during the operation in accordance with the stored-ROM program, and control the write operation into the test-only RAM.

What is claimed is:

1. A microcomputer comprising:
a storage installed in a chip for storing a stored program executed in a single-chip mode;
a test-only memory for sequentially storing address bus information and data bus information present on an address bus and data bus during operation based on the stored program;
an abnormal event detector for detecting an abnormal event in the operation based on the stored program, and for producing an abnormal event detection signal; and
a controller for halting writing the address bus information and data bus information into said test-only memory after the abnormal event in response to the abnormal event detection signal fed from said abnormal event detector.

2. The microcomputer according to claim 1, wherein said abnormal event detector consists of a counter for continuously counting a specified time interval in synchronization with a start instruction of the stored program, and wherein said counter produces the abnormal event detection signal by making a decision that the abnormal event occurs in the operation based on the stored program if the counting of the specified time interval becomes irregular.

3. The microcomputer according to claim 1, wherein said test-only memory has a memory capacity for storing the address bus information and data bus information of at least one instruction of the stored program, and successively writes the latest address bus information and data bus information over existing information during the operation based on the stored program.

4. The microcomputer according to claim 1, wherein said test-only memory starts storing the address bus information and data bus information in response to a test-mode entry signal that indicates a start point of abnormal event detection of the stored program.

5. The microcomputer according to claim 4, further comprising a test mode setting port for inputting the test-mode entry signal from an outside of the chip.

6. The microcomputer according to claim 4, further comprising a test mode setting register for setting the test-mode entry signal.

7. The microcomputer according to claim 6, wherein the test-mode entry signal includes area selection information that designates which one of said test-only memory and said test mode setting register should store the address bus information and data bus information, and wherein a CPU of said microcomputer decides a stored address of the address bus information and data bus information in accordance with the area selection information.

8. A microcomputer comprising:
a storage installed in a chip for storing a stored program executed in a single-chip mode;
a test mode setting register for setting a test-mode entry signal that indicates a starting time point of abnormal event detection of the stored program;
a CPU for successively writing address bus information and data bus information present on an address bus and data bus during operation based on the stored program at least into an unused area of said test mode setting register in response to a test-mode entry signal placed in said test mode setting register;
an abnormal event detector for detecting an abnormal event in the operation based on the stored program, and for producing an abnormal event detection signal; and
a controller for halting writing the address bus information and data bus information into the unused area of said test mode setting register after the abnormal event in response to the abnormal event detection signal fed from said abnormal event detector.

9. The microcomputer according to claim 8, wherein said CPU successively writes the address bus information and data bus information present on the address bus and data bus during the operation based on the stored program into an entire area of said test mode setting register, when the test-mode entry signal is placed in said test mode setting register, and the abnormal event detection of the stored program is started.
